(19) United States
(12) Patent Application Publication
(10) Pub. No.: US 2026/0154631 A1
(43) Pub. Date: Jun. 4, 2026

(54) TASK MANAGEMENT SYSTEM

(71) Applicant: David J. Schultz, Seattle, WA (US)

(72) Inventor: David J. Schultz, Seattle, WA (US)

(21) Appl. No.: 19/404,861

(22) Filed: Dec. 1, 2025

Related U.S. Application Data
(60) Provisional application No. 63/726,926, filed on Dec. 2, 2024.

(51) Int. Cl. G06Q 10/0631

(52) U.S. Cl. CPC G06Q 10/06311

(57) ABSTRACT

Methods, systems, apparatuses, and non-transitory computer-readable media are provided for streamlining data annotation tasks. A client device may send, to a server device, a request to initiate a data annotation session. The client device may receive a plurality of tasks to annotate data items. The plurality of tasks may be stored in a task queue of the client device. A first task to annotate a first data item may be identified from the task queue. The client device may receive user input indicating an annotation for the first data item. A second task to annotate a second data item may be identified from the task queue. The client device may receive user input indicating an annotation for the second data item.

### CROSS-REFERENCE TO RELATED APPLICATIONS

This application claims the benefit of priority of U.S. Provisional Ser. No. 63/726,926 , filed on Dec. 2, 2024, which is incorporated herein by reference in its entirety.

### TECHNICAL FIELD

The present disclosure generally relates to the field of data annotation. More specifically, the present disclosure relates to streamlining data annotation tasks.

### BACKGROUND

Computing devices may be configured to allow users to complete various types of tasks. In a networked system, computing devices may be connected via a network, and may be configured to allow users to complete various types of tasks within the networked system. If the number of tasks to be completed by users increases to a larger number, the challenges to efficiently facilitate the processing of the tasks using computing devices will only further grow.

### SUMMARY

Disclosed embodiments may include methods, systems, apparatuses, and non-transitory computer-readable media for streamlining data annotation tasks. In some examples, a client device may send, to a server device, a request to initiate a data annotation session. The client device may receive, from the server device, a plurality of tasks to annotate data items. The plurality of tasks to annotate the data items may be stored in a task queue of the client device. A first task to annotate a first data item may be identified from the task queue. A display of the first task may be caused via a graphical user interface associated with the client device. The client device may receive user input indicating an annotation for the first data item. After the receiving the user input indicating the annotation for the first data item, a second task to annotate a second data item may be identified from the task queue. A display of the second task may be caused via the graphical user interface associated with the client device. The client device may receive user input indicating an annotation for the second data item.

In some examples, based on completing the first task, the client device may send, to the server device, a request for a third task to annotate a third data item. The client device may receive, from the server device, the third task to annotate the third data item. The third task to annotate the third data item may be stored in the task queue of the client device.

In some examples, the first data item may include one or more of a textual data item, an image, or a video. The annotation for the first data item may include one or more of a textual annotation, a bounding box annotation, or a labeling annotation.

In some examples, the task queue of the client device may indicate an order for the plurality of tasks. For a task, stored in the task queue of the client device, that is to be rendered next according to the order, it may be determined whether the task includes a link to a data item stored in a storage other than the client device. Based on determining that the task includes the link to the data item stored in the storage, the client device may retrieve the data item stored in the storage.

In some examples, an intermediate task state during a time to annotate the first data item may be recorded. Based on a request to reload the first data item, a display of the intermediate task state may be caused.

In some examples, the first task may be stored in a task history queue after a completion of the first task. The second task may be stored in the task history queue after a completion of the second task.

In some examples, the causing the display of the first task via the graphical user interface may be based on rendering the first task according to a task blueprint.

In some examples, the task blueprint may include one or more of: a task interface; or one or more rules for processing data associated with a grouping of tasks.

In some examples, the task blueprint may be configured based on a preview service configured to preview a task interface with sample task data.

In some examples, each task of the plurality of tasks may include a Hypertext Markup Language (HTML) document.

In some examples, the client device may receive, from the server device, one or more of: training tasks; or test tasks. The request to initiate the data annotation session may be approved based on completing the training tasks or the test tasks.

In some examples, the display of the first task via the graphical user interface associated with the client device may include one or more of: a timer, a pause button, a skip button, a shelve button, a finish-session button, or a last-task button.

In some examples, the plurality of tasks may be retrieved from an assignment queue associated with the server device based on an identity of a user creating the request to initiate the data annotation session.

In some examples, the client device may send, to the server device, one or more of the annotation for the first data item or the annotation for the second data item.

In some examples, the task queue of the client device may include a preloaded task queue configured to preload a number of tasks, to output a task for display, and to replenish with additional tasks from the server device.

Consistent with disclosed embodiments, non-transitory computer-readable media may store instructions that, when executed by one or more processors, may cause the one or more processors to perform any of the processes described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 illustrates an example task handling system, consistent with some embodiments of the present disclosure.

FIG. 2 illustrates an example task blueprint management system, consistent with some embodiments of the present disclosure.

FIGS. 3A-3F illustrate various task interface elements, consistent with some embodiments of the present disclosure.

FIGS. 4A-4C illustrate example task completion interface elements, consistent with some embodiments of the present disclosure.

FIGS. 5A-5D illustrate various interface elements for a blueprint editor, consistent with some embodiments of the present disclosure.

FIG. 6 illustrates an example machine of a computer system, consistent with some embodiments of the present disclosure.

FIG. 7 illustrates a flowchart of an example method for streamlining data annotation tasks, consistent with some embodiments of the present disclosure.

### DETAILED DESCRIPTION

The following detailed description refers to the accompanying drawings. Wherever possible, the same reference numbers are used in the drawings and the following description to refer to the same or similar parts. While several illustrative examples are described herein, modifications, adaptations, and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the specific embodiments and examples, but is inclusive of general principles described herein and illustrated in the figures in addition to the general principles encompassed by the appended claims.

Machine learning (ML) technology is a type of artificial intelligence technology concerned with the development of models that can learn from data and generalize to unseen data, and thus perform tasks without explicit instructions. ML technology includes various sub-fields, such as neural networks, tree-based classifiers, reservoir computers, etc. ML finds application in many fields, such as natural language processing, computer vision, speech recognition, agriculture, medicine, etc. ML implementations may use various learning techniques that use a labeled corpus data (e.g., a ground truth dataset), such as supervised learning, reinforcement learning, etc. Generation of labeled data is often accomplished via tasks distributed to humans (“workers”). For instance, generation of a labeled corpus might require hundreds or thousands of different tasks. Various technical issues commonly occur in task systems that may impact the quality/size of ground truth datasets. For example, rendering of an asset from a remote storage location (e.g., a cloud storage location such as an Amazon Web Services (AWS) storage instance) may incur delays of a few seconds. Over the course of thousands of tasks, this adds hours of delay which could be otherwise used to label additional data. As another example, one of the core challenges in most annotation projects is ensuring that workers are properly trained and performing the task properly.

Tasks are often distributed and performed via crowdwork which assign to workers on a one-by-one basis when a worker requests a new task to work on. Each task is a fully rendered HTML document stored on the server containing the task interface with the data for that individual task populated into the HTML. When the task is displayed to the worker, the HTML is simply rendered into an HTML iframe within their task portal. When the worker submits the task, the results are sent back to their service and a new task is retrieved. The storage and distribution of these rendered documents may incur delay and excess storage costs.

Aspects of the described technology may provide a task management service that allows users to distribute small tasks (e.g., annotation tasks used for AI/ML development) to teams of workers. For instance, the described technology may be instantiated in managed systems (e.g., where requesters manage the team of workers), or unmanaged services such as Amazon Mechanical Turk (MTurk). Aspects of the described technology may support managing data for tasks, tracking worker behavior, and otherwise managing the data pipeline for each task. Aspects may further provide blueprint creation/management, which may allow users to create task blueprints that contain a task interface and data processing steps that will be applied to each task. Further aspects may provide a task portal which provides a user interface for workers to interact with tasks. Further aspects may provide an assignment queue service that determines what tasks to display to workers and in what order. Further aspects may provide task management utilities and tools to review the results of tasks and the performance and accuracy of workers.

In some examples, the processes described herein may be used for data annotation for artificial intelligence technology. For example, various types of data items to be annotated using the system described herein may be used for training machine learning models. A data sample may be generated by combining a data item and its corresponding annotation produced using the system described herein. Data samples as such may form a dataset for training, validating, or testing machine learning models, or for other purposes associated with machine learning models or artificial intelligence technology. In some examples, the processes as described herein may be used as a tool for building training data for artificial intelligence or machine learning (AI/ML).

In some examples, the processes described herein may be used for data annotation for any desired purposes. For example, the system described herein may also be used for gathering or annotating data for uses such as finding data on a website or reviewing data elements to evaluate.

The system described herein may provide a mechanism to orchestrate the completion of tasks. In some examples, the tasks may include small, repetitive tasks. One example use case may be the annotation of AI/ML training data by providing the human evaluations that an artificial intelligence model may be trained to emulate. These tasks may also be used to provide assessments of the quality of a trained model (e.g., a trained machine learning model) or provide corrections that may be used in refining the model.

In some examples, a user of the system described herein may simply create task(s) and have humans complete the task(s). For example, a user may have a spreadsheet of a large number of products (e.g., 5,000 products) that the user may intend to quickly categorize using a custom structure (e.g., the user may be asked to produce a report to present to a client very quickly). Using the system described herein, the user may quickly set up this work assignment and have the members of the team annotate the products quickly. In some examples, the nuances of the products to be categorized may suggest human annotation, and the system described herein may facilitate the completion of the annotation.

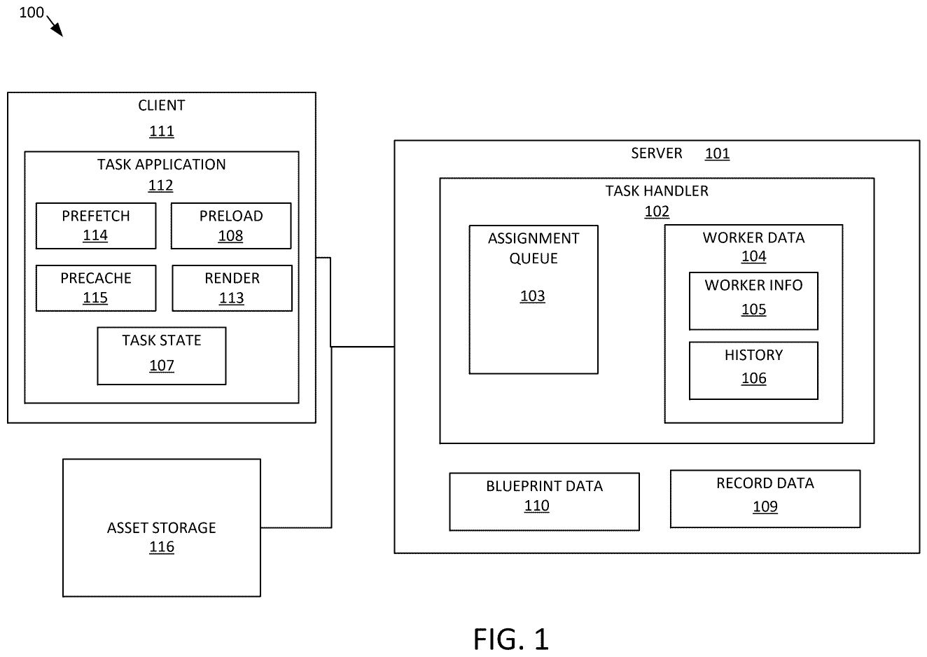

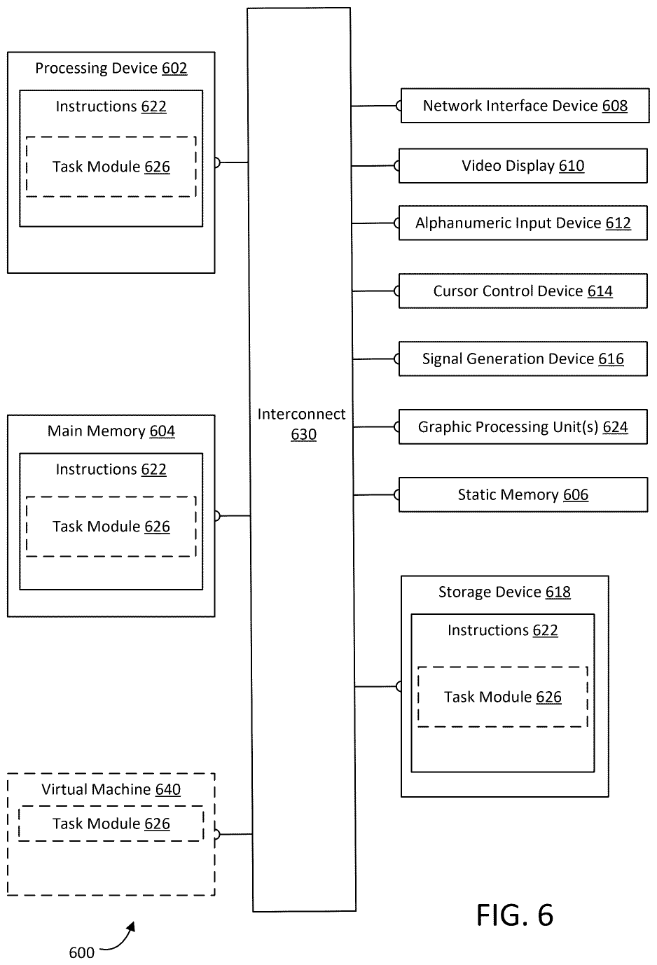

FIG. 1 illustrates an example task handling system 100. For example, system 100 may comprise a server 101 and a client 111. For instance, server 101 and client 111 may be implementations of a computer system 600 as described with respect to FIG. 6. As an example, server 101 may comprise task handler logic 102, such as instructions stored on a non-transitory computer readable medium and executed by a server processor (e.g., via virtual machine, container, bare-metal execution, etc.). Task handler logic 102 may be referred to as “task handler 102” or “task handler service 102” in various contexts. Of course, server 101 need not be a single machine. For instance, task handler 102 may be implemented via distributed execution (e.g., “micro-services”). Some examples may be described with respect to a task framework that is coded such that a task application 112 executed by a client 111 performs certain functions while a server-side task application (e.g., task handler 102 or blueprint management application 202) performs other functions. Unless indicated otherwise, functionality may be distributed in any manner between client 111 and server 101 (e.g., task history 106 may be executed client-side by task application 112, server-side by server 101, or a combination thereof.

In some implementations, task handler 102 may comprise assignment queue logic 103. In some implementations, task handler 102 may dynamically assign tasks to workers based on their profile and performance. For example, when a worker begins working on a new blueprint, a training tasks may be assigned, such as a first/example task that they will be shown to review and/or acknowledge instructions. In some implementations, task handler 102 may serve a worker a task via client 111. For instance, client 111 may comprise a web browser or other application (e.g., a task application with embedded html renderer) (“task application 112”). For example, task application 112 may display one or more training tasks to allow workers to work on example tasks and get immediate feedback on the accuracy of their submission. This may improve annotation results by increasing worker confidence or reducing errors.

In some implementations, task handler 102 may provide one or more test tasks to be rendered 113 by task application 112 to validate that a worker is performing the task accurately. In some implementations, task handler 102 may include various worker-related data 104. For instance, worker data 104 may include worker information 105, such as past performance data, qualification data (e.g., blueprints/task types that the worker is able to perform), experience data (e.g., completion rates/numbers of test tasks, executing a threshold number of tasks, etc.), etc. In some implementations, task handler 102 may suspend a worker from future work on a task if their performance as reflected in worker information 105 falls below a numeric threshold specified by a test policy, for example. In some implementations, task handler 102 may execute test policies, such as serving remedial training tasks to reinstate a worker to perform the task. In some implementations, task handler 102 may serve test tasks will be displayed to workers with regular frequency to ensure ongoing performance. For instance, the operation of task handler 102 in these respects may be controlled by configuration parameters, such as a test policy.

In some implementations, task handler 102 may comprise an assignment queue 103 comprising regular tasks will be assigned to workers. For example, task handler 102 may populate assignment queue 103 based on blueprints retrieved from a blueprint data storage 110 and record data retrieved from a record data storage 109. In further implementations, task handler 102 may include logic to assign tasks to workers based on various conditions such as their measured accuracy or other quality metric, which may be applied independently or with respect to comparison of another worker's accuracy.

In some implementations, task application 112 may include a queue 108 for a worker. For example, responsive to a request from a client to initiate a session (e.g., a worker completing tasks based on a session blueprint), the task handler 102 may pre-assign tasks from assignment queue 103 to the worker to populate the queue 108. In some implementations, the pre-assigned tasks may be loaded into a preloaded task queue 108. For instance, when a client 111 operated by a worker begins working on a blueprint, the task application 112 may request tasks a queue 108 of tasks to preload for the worker. For instance, the task preload queue 108 may comprise a configurable number of tasks, such as a number configurable by a worker via client 111, configurable via a requester/user via blueprint/task definition, via a preset/default value (e.g., between 1-10 tasks, such as 5 tasks). As the worker completes tasks via task application 112, it may request tasks to be added to the queue 108, so there is always a queue of upcoming tasks on the client to be displayed (if tasks are available). This may improve annotation operations, such as by speeding up annotation by avoiding a server round-trip communication by loading a next task from preload queue 108. For instance, loading a next task may take up to around ten seconds when conducting round-trip next task assignment. In some implementations, preload queue 108 may be a component of task handler 102. For instance, this may avoid delays in task assignment resulting from loading a next task from assignment queue 103 (e.g., by avoiding database queries, etc.).

In some implementations, task handler 102 stores tasks (e.g., in assignment queue 103 or record data 109, etc.) as a data interchange object (e.g., a JSON object) without (or in addition to) storing the rendered HTML for each task. In these implementations, when task application 112 loads a task it may retrieve an HTML template according to a task blueprint. Task application 112 may execute a rendering service 113 to render tasks. For example, task application 112 may comprise a client-side module (WASM) to render data into a template. This approach may reduce the amount of data that must be sent to the client computer 111, which may be particularly beneficial in bandwidth-constrained environments. In some implementations, rendering framework 113 may further support rendering the worker's answer when displaying the results of training tasks.

In some implementations, task application 112 may include an asset prefetcher 114. For example, asset prefetcher may be a module of renderer 113. Prefetcher 114 may identify assets (images, video) that will need to be loaded into the task interface (e.g., based on the tasks loaded into the preload queue 108). For example, these assets are often stored securely in cloud storage, hosted storage, a storage-area network, etc., such as in AWS S3 buckets (asset storage 116). In some cases, prefetcher 114 may execute a call to retrieve a temporary URL to display them in the worker's application 112. Prefetcher 114 may then execute a subsequent call to retrieve the asset itself. In some cases, the retrieval of these assets can take several seconds, particularly for larger video files. Task application 112 may comprise a service worker 115 to pre-cache these assets for renderer 113 (e.g., to pre-cache the assets in the browser). When the pre-cached task is loaded, the cached value can be immediately displayed, further improving the rate of task performance.

In some implementations, task application 112 may include an intermediate task state storage 107. As a worker enters data for a task, particularly for tasks that take a long time to complete such as image and video annotation, it's not uncommon for workers to lose track of progress on a task due to technical issues. To address this, task application 112 may stores intermediate progress 107 in the service so that the data can be restored to the task interface if the page is reloaded.

In some implementations, task handler 102 may comprise a task history queue 106 as part of worker data 104. In such implementations, a worker submits a task, it may be put in a queue 106 of past tasks that they can return to. Queue 106 may have a configurable or set length (e.g., 1-10, such as 5, tasks). For instance, history queue 106 may provide an opportunity for a worker to correct a past task if they realize they've made a mistake. As another example, task application 112 may comprise a history queue 106. For instance, task application 112 may buffer completed tasks prior to submitting them to task handler 102.

Task application 112 may comprise code for further functionality such as an interface having control elements, such pause, shelve tasks, finish session, and last task buttons. For example, task application 112 may clear/return the preloaded queue 108 responsive to a finish session input, or may serve a next task to prefetcher 114/renderer 113 and return the remaining tasks, etc. As another example, a shelve tasks input may cause an intermediate state to be stored by task handler 102 (e.g., stored as worker data 104).

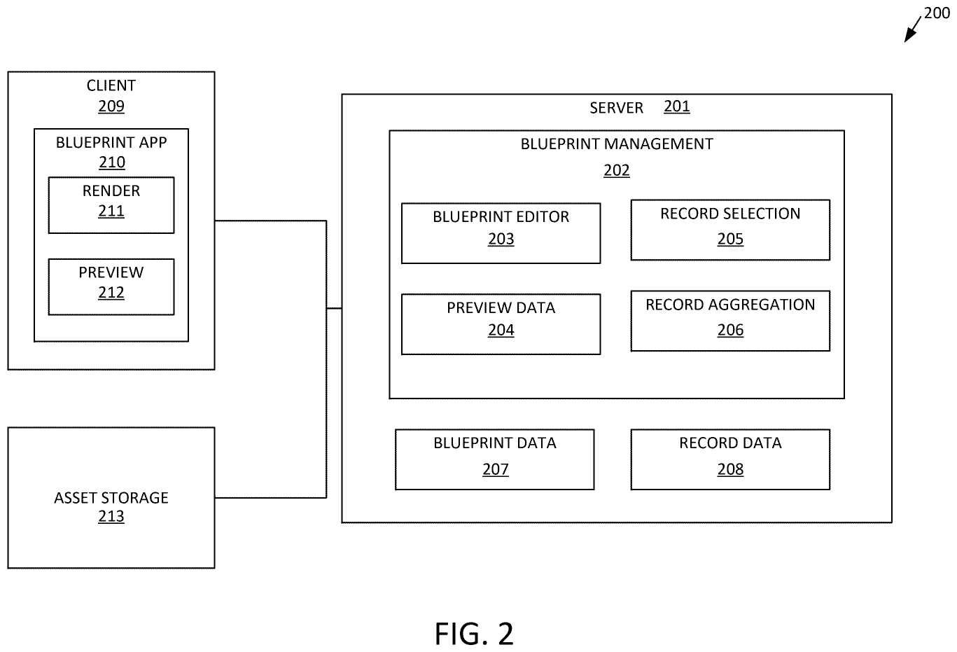

FIG. 2 illustrates an example task blueprint management system 200. For example, system 201 may comprise a server 201 and a client 209. For instance, server 201 and client 209 may be implementations of a computer system 600 as described with respect to FIG. 6. In some cases, server 201 and client 209 may comprise implementations of server 101 and client 111 of FIG. 1. As an example, server 201 may comprise blueprint management logic 202, such as instructions stored on a non-transitory computer readable medium and executed by a server processor (e.g., via virtual machine, container, bare-metal execution, etc.). Blueprint management logic 202 may be referred to as “blueprint manager 202” or “blueprint service 202” in various contexts.

In some implementations, blueprint manager 202 may comprise code to perform various services. For instance, blueprint manager 202 may include record management functions, such as record selection 205 (e.g., selecting records that are sent as tasks, etc.). As another example, blueprint manager 202 may comprise a record data aggregation function 206. For example, record data aggregator 206 may provide data to provide data regarding record review statuses, etc.

In some implementations, tasks may be defined via task blueprints. For instance, blueprints may be retained in a blueprint data storage 207. A blueprint may comprise any aspects of a repeatable task, including the interface that will be shown to workers (e.g., the interface displayed by renderer 113 during task performance) as well as the data processing steps that will be invoked before and after each task. The data processing steps may be configured by custom/reusable code (e.g., “bots”). For example, a blueprint design may include small pieces of code users can use at various stages. In some cases, a blueprint may define one or more task stages, such as: Launch (Augment or clean the input for a task before it is shown to a worker); Response (Augment or clean the form response from the task interface); and/or Result (Consolidate responses from multiple workers into a single response for a task).

In some implementations, system 200 may comprise a client device 209 to execute blueprint builder application code 210 (“blueprint application 210”). For example, blueprint application 210 may comprise a web-application executed in a web-browser or dedicated application comprising an interface and a renderer 211. In some implementations, blueprint application may include a live preview service 212 to preview the task interface while the blueprint is being built (e.g., so that a user can preview what will be displayed to workers as they design the blueprint). When building a blueprint, preview service 212 may support users'understanding of the data at each stage and preview the task interface.

In some implementations, blueprint application 210 may receive a file uploaded by a user containing sample records of task data. In some implementations, this data is processed and stored with the blueprint in blueprint data storage 207. For instance, the stored samples may be loaded by a blueprint editing service 203 to edit the blueprint at a later time. In some implementations, blueprint application 210 may process the sample data and display the results within the user interface in real-time as users make changes to the task interface and bots. For instance, the task interface may be rendered with sample task data based on a blueprint draft. In some implementations, users can complete and submit the task to view the output from the task interface and any subsequent processing steps, such as identification of task assets at an asset storage 213. In some implementations, a set of tasks may be loaded to a task assignment queue (e.g., assignment queue 103) when received by blueprint manager 202 (e.g., with user confirmation).

The following provides an example workflow, such as a process followed by a user interacting with blueprint application 210 executed by a client device 209. Of course, the described technology may be implemented with any suitable user interface/workflow: (1) User uploads a sample file containing task data via blueprint application 210; (2) A live preview pane 212 (e.g., a pane/window/frame of a web application, such as at the bottom of the page) displays an input tab containing a record from that data using renderer 211; (3) User creates a task template; (4) A control element to navigate to a task preview (e.g., task tab) is added to live preview 212 to display the task interface; (5) Blueprint 210 receives a task submission signal (e.g., the user submits the task); (6) A form response tab is added, showing the output of the HTML form implementing a response task template; (7) The user edits the task by creating or selecting response bots via blueprint application 210 to control task response rendering or associated operations; (8) A response display (e.g., a tab control element) is added to preview pane 212, showing the processed results from the task; (9) Blueprint application 210 may provide an interface for the user to pin one or multiple responses from the task interface (e.g., sample responses); (10) User edits the task via blueprint app 210 by creating or selecting a result bot; (11) A result tab is added to preview pane 212, showing the final output comprising the pinned responses.

In some implementations, blueprint manager 202 may include a record selection service 205. For instance, blueprint application 210 may provide an interface to record selection service 205 for a user to choose different records from the input file to display various tasks.

In some implementations, blueprint manager 202 may include a record aggregation service 206. For instance, blueprint 210 may interface with record aggregation service 206 to support aggregating multiple inputs into a single task (e.g., if enabled by a configuration). In some implementations, blueprint application 210 may display additional interfaces based on the aggregation, such as additional tabs that will be included to display the additional processing stages with respect to record aggregation.

In some implementations, blueprint application 210 may provide an interface for users to create Input and Result templates to more easily render the data at those stages. For instance, this may be particularly beneficial for complex data. When specified, live preview 212 may provide a control option to give users the option to view either the raw data or the rendered representation.

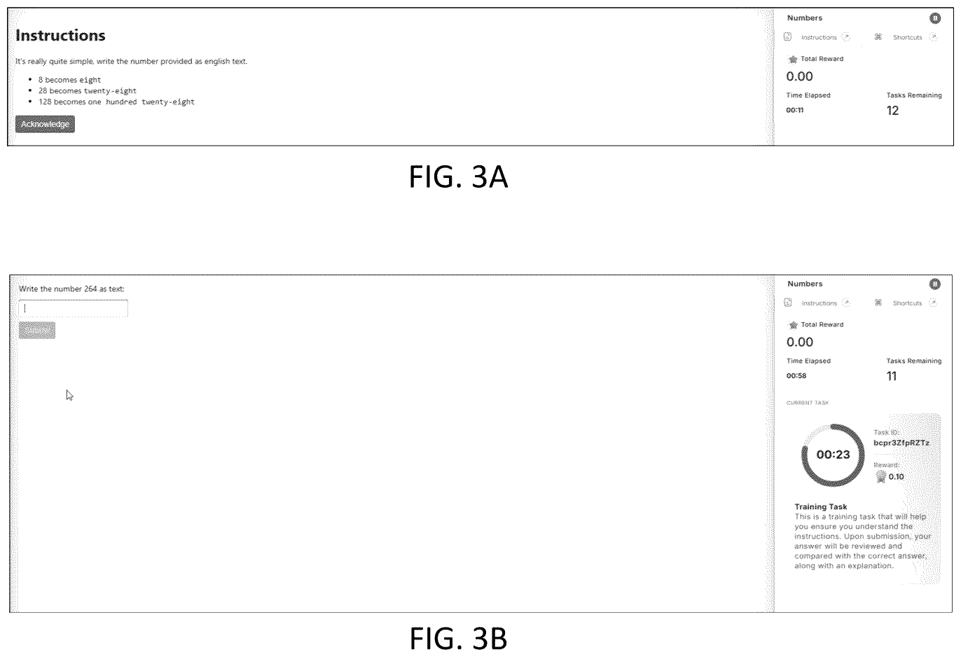

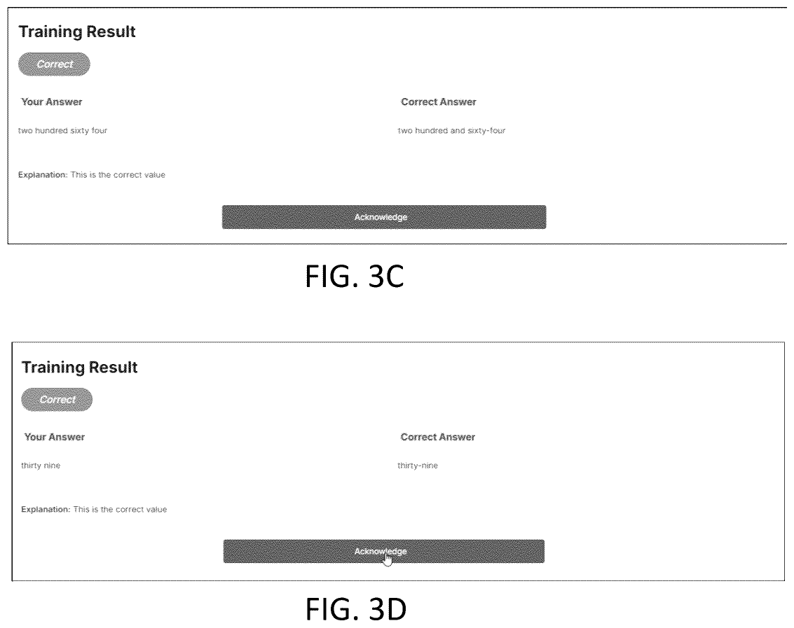

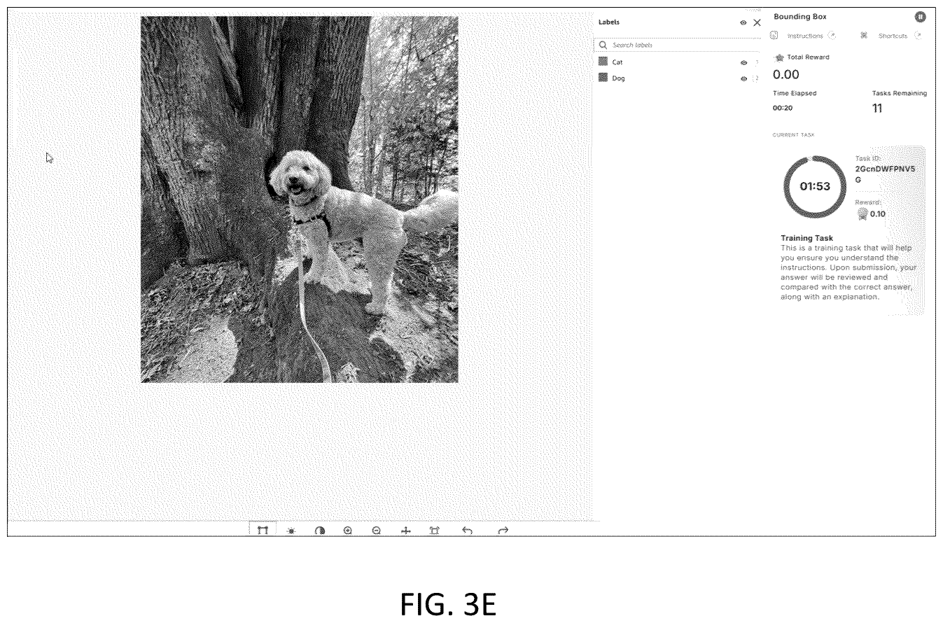

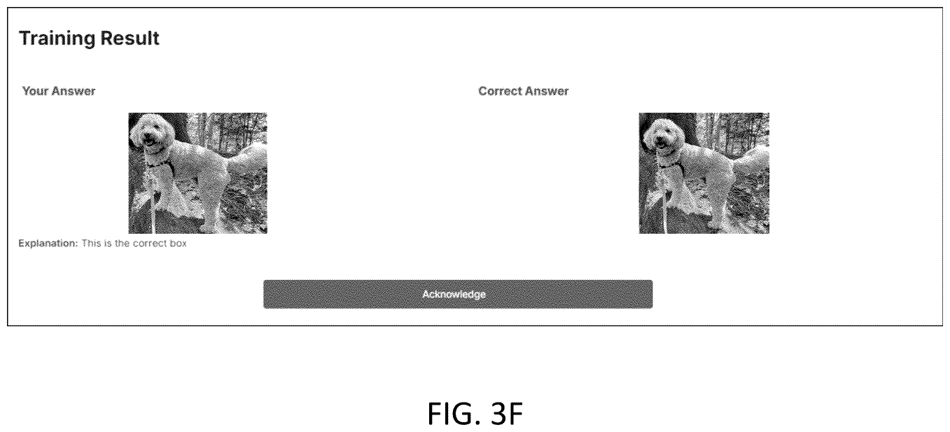

FIGS. 3-5 illustrate various example interface displays, such as might be presented via a client application such as task application 112 or blueprint application 210.

FIGS. 3A-3F illustrate various task interface elements, such as might be displayed during a worker training session or worker task performance session. For example, the illustrated elements may be displayed according to a template from a task blueprint.

FIG. 3A illustrates an example task instructions display.

FIG. 3B illustrates an example task response input interface including a task (e.g., “write the number 264 as text” and a text field and submission control element for a task response.

FIGS. 3C and 3D illustrate example task result interface displays, such as may be provided after a training session. In some implementations, blueprint templates may define correct results as well as patterns that are considered correct results (e.g., via a regular expression or other text pattern).

FIG. 3E illustrates another example task performance interface display. For example, the illustrated interface includes an image and labels for a worker to select from. For instance, such images may be retrieved via prefetching/preloading services as described above.

FIG. 3F illustrates an example result display for a training task comprising a user identifying a dog within an image (e.g., via a bounding box interface). For instance, a training task template from a task blueprint may include a range of bounding box coordinates that are considered correct answers.

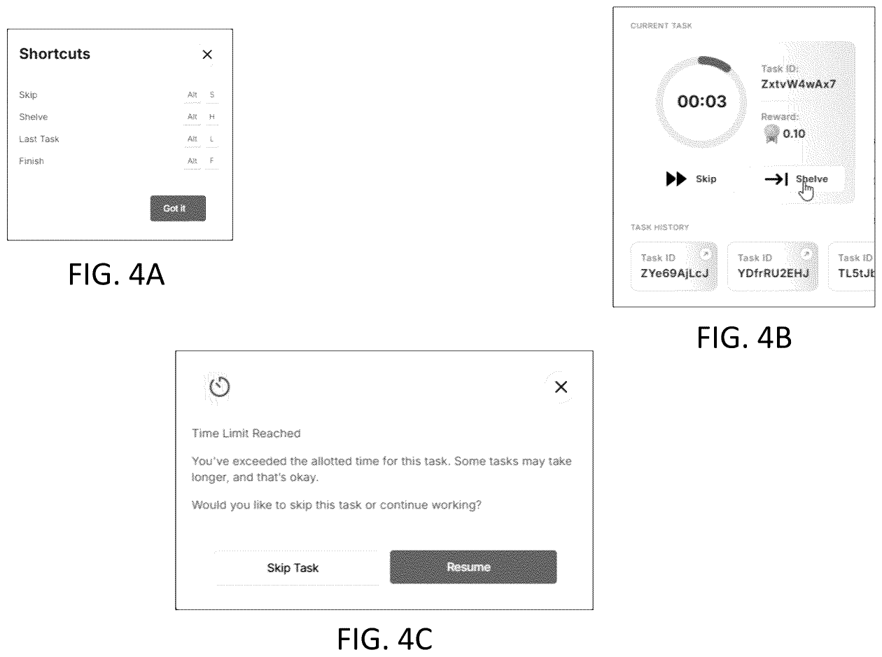

FIGS. 4A-4C illustrate example task completion interface elements, such as may be provided by a task application 112.

FIG. 4A illustrates example user shortcut key combinations for various operations described above.

FIG. 4B illustrates an example interface pane that may be provided during a task performance session, including control elements for various functions as described above.

FIG. 4C illustrates an example interface element that may be displayed according to blueprint code. For instance, a blueprint may define a maximum allowed time for a task, or other informational elements regarding the task to be displayed.

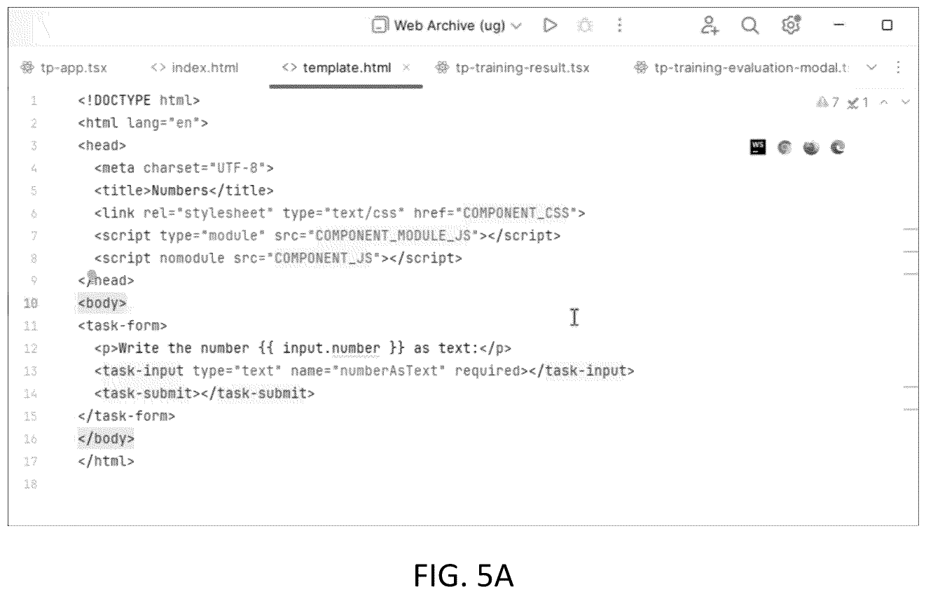

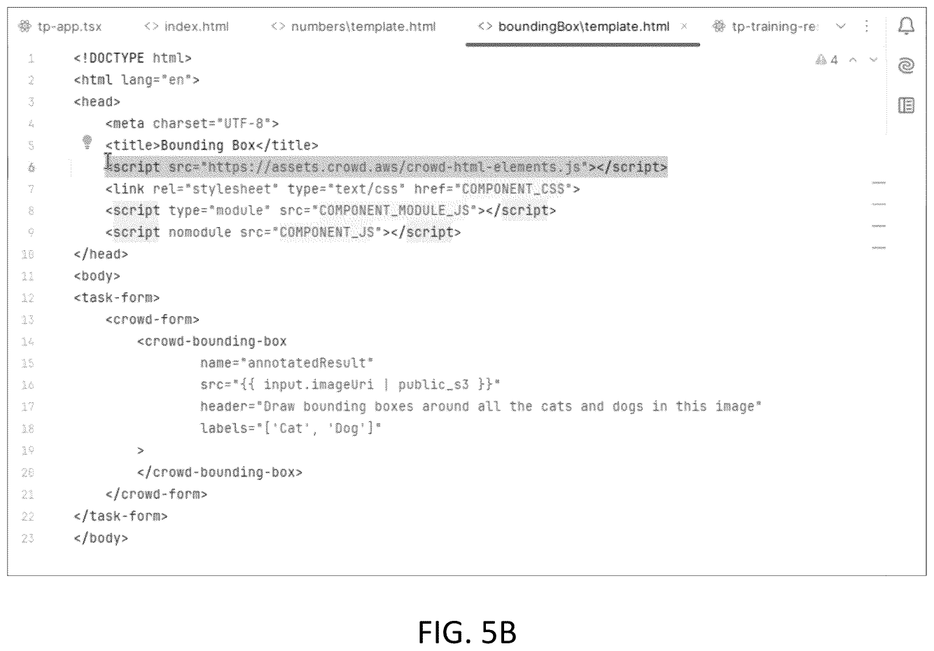

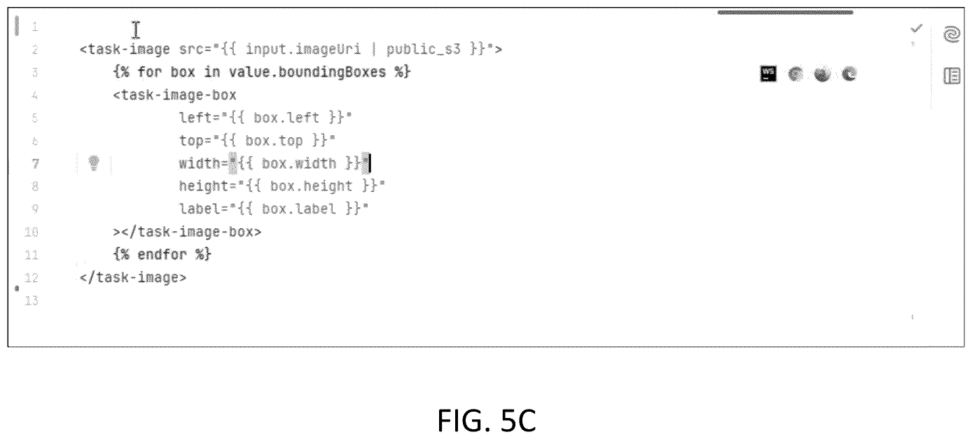

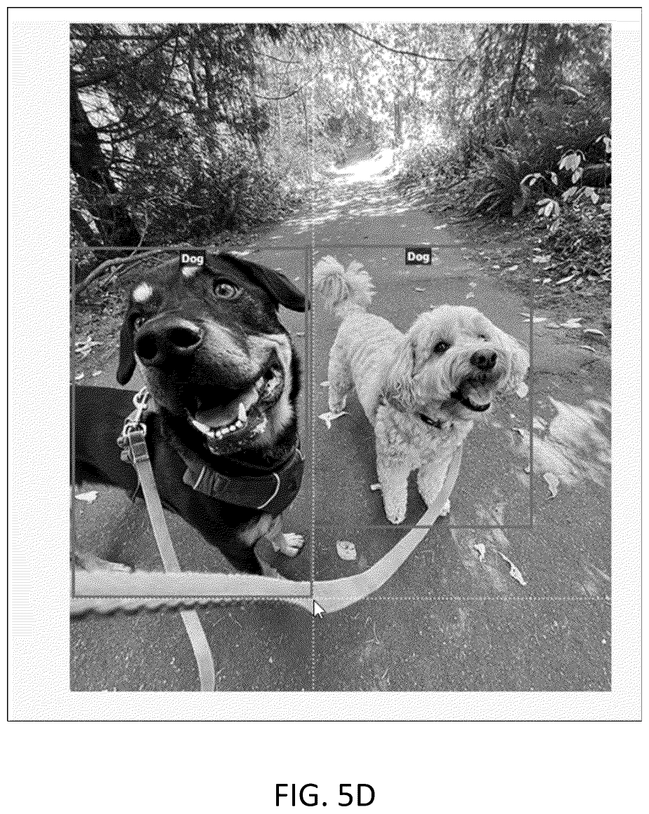

FIGS. 5A-5D illustrate various interface elements for a blueprint editor, such as provided by blueprint application 210.

FIG. 5A illustrates an example task template for a task blueprint (e.g., a template for tasks illustrated with respect to FIG. 3B).

FIG. 5B illustrates an example task template for an image annotation task. As illustrated, a task template may include template information for an asset storage. As described above, a client device may prefetch assets for upcoming tasks based on such templates.

FIG. 5C illustrates an example response definition template including data field definitions for bounding boxes and associated labels.

FIG. 5D illustrates an example live preview pane 5D, such as may be displayed by a client 209 executing a blueprint application 210 as described above.

FIG. 6 is an illustration of an example machine of a computer system 600 within which a set of instructions, for causing the machine to perform any one or more of the methodologies discussed herein, may be executed. In alternative implementations, the machine may be connected (such as networked) to other machines in a LAN, an intranet, an extranet, and/or the Internet.

The machine may operate in the capacity of a server or a client machine in a client-server network environment, as a peer machine in a peer-to-peer (or distributed) network environment, or as a server or a client machine in a cloud computing infrastructure or environment. The machine may be a personal computer (PC), a tablet PC, a smartphone, a web appliance, a virtual machine or software container executed on a host device, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (such as read-only memory (ROM), flash memory, dynamic random-access memory (DRAM), resistive RAM (reRAM), etc.), a static or persistent memory 606 (such as flash memory, static random access memory (SRAM), etc.), and a data storage device 618, which communicate with each other via an interconnect 630.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 622 for performing the operations and steps discussed herein.

The computer system 600 may further include a network interface device 608 for connecting to the LAN, intranet, internet, and/or the extranet. The computer system 600 also may include a video display unit 610 (such as a liquid crystal display (LCD) or light-emitting diode (LED) display), an alphanumeric input device 612 (such as a keyboard), a cursor control device 614 (such as a mouse), a signal generation device 616 (such as a speaker), and a graphic processing unit 624 (such as a graphics card or integrated graphics unit of processing device 602).

The data storage device 618 may be a machine-readable storage medium (also known as a computer-readable medium) on which is stored one or more sets of instructions or software 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting machine-readable storage media.

In one implementation, the instructions 622 include instructions for an interactive analysis portal and/or a software library containing methods that function as an interactive analysis portal. The instructions 622 may further include instructions for a task module 626. For example, task module instruction 626 may be executed to implement a task application such as task application 112, task handler 102, blueprint application 210, or blueprint manager 202. While the data storage device 618/machine-readable storage medium is shown in an example implementation to be a single medium, the term “machine-readable storage medium” should be taken to include a single medium or multiple media (such as a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media. The term “machine-readable storage medium” shall accordingly exclude transitory storage mediums such as signals unless otherwise specified by identifying the machine readable storage medium as a transitory storage medium or transitory machine-readable storage medium.

In another implementation, a virtual machine 640 may include a module for executing instructions for a task module 626. In computing, a virtual machine (VM) is an emulation of a computer system. Virtual machines are based on computer architectures and provide functionality of a physical computer. Their implementations may involve specialized hardware, software, or a combination of hardware and software.

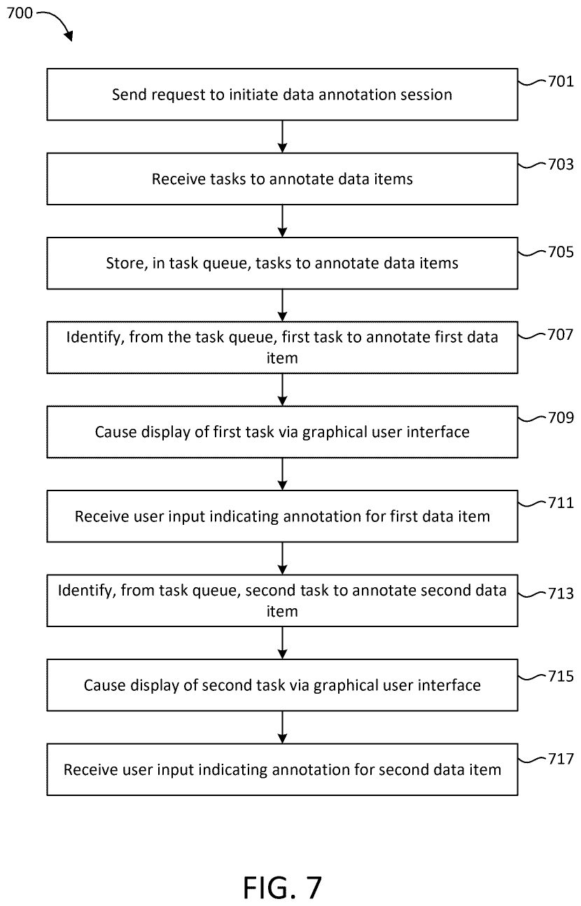

FIG. 7 illustrates a flowchart of an example method 700 for streamlining data annotation tasks, consistent with some embodiments of the present disclosure. In step 701, a client device may send, to a server device, a request to initiate a data annotation session. In step 703, the client device may receive, from the server device, a plurality of tasks to annotate data items. In step 705, the client device may store, in a task queue of the client device, the plurality of tasks to annotate the data items. In step 707, the client device may identify, from the task queue, a first task to annotate a first data item. In step 709, the client device may cause a display of the first task via a graphical user interface associated with the client device. In step 711, the client device may receive user input indicating an annotation for the first data item. In step 713, the client device may, after the receiving the user input indicating the annotation for the first data item, identify, from the task queue, a second task to annotate a second data item. In step 715, the client device may cause a display of the second task via the graphical user interface associated with the client device. In step 717, the client device may receive user input indicating an annotation for the second data item.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “providing” or “calculating” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of storage or memory, such as solid-state drives, hard disks, optical disks, CD-ROMs, and magnetic-optical disks, read-only memories (ROMs), random access memories (RAMs), EPROMs, EEPROMs, magnetic or optical cards, or any other type of media suitable for storing electronic instructions, each coupled to a computer system interconnect.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present technology may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (such as a computer). For example, a machine-readable (such as computer-readable) medium includes a machine (such as a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

As used herein, unless context dictates otherwise, the term “or” refers to the inclusive use of the term (e.g., the logical OR). Unless context dictates otherwise, the term “exclusive” will be used to refer to the exclusive use of the term (e.g., the logical XOR). For example, the phrase “A, B, or C” includes the sets {A}, {B}, {C}, {A, B}, {A, C}, {B, C}, and {A, B, C}, while the phrase “A, B, or C, exclusive” includes the sets {A}, {B}, and {C}.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

While illustrative examples have been described herein, the scope includes any and all embodiments having equivalent elements, modifications, omissions, combinations (e.g., of aspects across various examples), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any desired manner, including by reordering steps or inserting or deleting steps. It is intended, therefore, that the specification and examples be considered as exemplary only, with a true scope and spirit being indicated by the following claims and their full scope of equivalents.

1. A method for streamlining data annotation tasks, the method comprising:
sending, by a client device and to a server device, a request to initiate a data annotation session;
receiving, by the client device and from the server device, a plurality of tasks to annotate data items;
storing, in a task queue of the client device, the plurality of tasks to annotate the data items;
identifying, from the task queue, a first task to annotate a first data item;
causing a display of the first task via a graphical user interface associated with the client device;
receiving, by the client device, user input indicating an annotation for the first data item;
after the receiving the user input indicating the annotation for the first data item, identifying, from the task queue, a second task to annotate a second data item;
causing a display of the second task via the graphical user interface associated with the client device; and
receiving, by the client device, user input indicating an annotation for the second data item.

2. The method of claim 1, further comprising:
based on completing the first task, sending, by the client device and to the server device, a request for a third task to annotate a third data item;
receiving, by the client device and from the server device, the third task to annotate the third data item; and
storing, in the task queue of the client device, the third task to annotate the third data item.

3. The method of claim 1, wherein the first data item comprises one or more of a textual data item, an image, or a video, and wherein the annotation for the first data item comprises one or more of a textual annotation, a bounding box annotation, or a labeling annotation.

4. The method of claim 1, wherein the task queue of the client device indicates an order for the plurality of tasks, and wherein the method further comprises:
for a task, stored in the task queue of the client device, that is to be rendered next according to the order, determining whether the task comprises a link to a data item stored in a storage other than the client device; and
based on determining that the task comprises the link to the data item stored in the storage, retrieving, by the client device, the data item stored in the storage.

5. The method of claim 1, further comprising:
recording an intermediate task state during a time to annotate the first data item; and
based on a request to reload the first data item, causing a display of the intermediate task state.

6. The method of claim 1, wherein the first task is stored in a task history queue after a completion of the first task, and wherein the second task is stored in the task history queue after a completion of the second task.

7. The method of claim 1, wherein the causing the display of the first task via the graphical user interface is based on rendering the first task according to a task blueprint.

8. The method of claim 7, wherein the task blueprint comprises one or more of:
a task interface; or
one or more rules for processing data associated with a grouping of tasks.

9. The method of claim 7, wherein the task blueprint is configured based on a preview service configured to preview a task interface with sample task data.

10. The method of claim 1, wherein each task of the plurality of tasks comprises a Hypertext Markup Language (HTML) document.

11. The method of claim 1, further comprising:
receiving, by the client device and from the server device, one or more of:
training tasks; or
test tasks;
wherein the request to initiate the data annotation session is approved based on completing the training tasks or the test tasks.

12. The method of claim 1, wherein the display of the first task via the graphical user interface associated with the client device comprises one or more of: a timer, a pause button, a skip button, a shelve button, a finish-session button, or a last-task button.

13. The method of claim 1, wherein the plurality of tasks are retrieved from an assignment queue associated with the server device based on an identity of a user creating the request to initiate the data annotation session.

14. The method of claim 1, further comprising:
sending, by the client device and to the server device, one or more of the annotation for the first data item or the annotation for the second data item.

15. The method of claim 1, wherein the task queue of the client device comprises a preloaded task queue configured to preload a number of tasks, to output a task for display, and to replenish with additional tasks from the server device.

16. A non-transitory computer-readable medium storing instructions that, when executed by one or more processors, cause the one or more processors to:
send, to a server device, a request to initiate a data annotation session;
receive, from the server device, a plurality of tasks to annotate data items;
store, in a task queue, the plurality of tasks to annotate the data items;
identify, from the task queue, a first task to annotate a first data item;
cause a display of the first task via a graphical user interface;
receive user input indicating an annotation for the first data item;
after the receiving the user input indicating the annotation for the first data item, identify, from the task queue, a second task to annotate a second data item;
cause a display of the second task via the graphical user interface; and
receive user input indicating an annotation for the second data item.

17. The non-transitory computer-readable medium of claim 16, wherein the instructions, when executed by the one or more processors, further cause the one or more processors to:
based on completing the first task, send, to the server device, a request for a third task to annotate a third data item;
receive, from the server device, the third task to annotate the third data item; and
store, in the task queue, the third task to annotate the third data item.

18. The non-transitory computer-readable medium of claim 16, wherein the first data item comprises one or more of a textual data item, an image, or a video, and wherein the annotation for the first data item comprises one or more of a textual annotation, a bounding box annotation, or a labeling annotation.

19. A system for streamlining data annotation tasks, the system comprising:
a client device and a server device;
wherein the client device is configured to:
send, to the server device, a request to initiate a data annotation session;
receive, from the server device, a plurality of tasks to annotate data items;
store, in a task queue of the client device, the plurality of tasks to annotate the data items;
identify, from the task queue, a first task to annotate a first data item;
cause a display of the first task via a graphical user interface associated with the client device;
receive user input indicating an annotation for the first data item;
after the receiving the user input indicating the annotation for the first data item, identify, from the task queue, a second task to annotate a second data item;
cause a display of the second task via the graphical user interface associated with the client device; and
receive user input indicating an annotation for the second data item; and
wherein the server device is configured to:
receive, from the client device, the request to initiate the data annotation session; and
send, to the client device, the plurality of tasks to annotate the data items.

20. The system of claim 19, wherein the client device is further configured to:
based on completing the first task, send, to the server device, a request for a third task to annotate a third data item;
receive, from the server device, the third task to annotate the third data item; and
store, in the task queue of the client device, the third task to annotate the third data item.
